(19) United States
(12) Patent Application Publication
(10) Pub. No.: US 2012/0138648 A1
(43) Pub. Date: Jun. 7, 2012

(54) Dip gripper

(76) Inventor: Andrew Joseph Moceo, II, Nashville, TN (US)

(21) Appl. No.: 12/928,072

(22) Filed: Dec. 3, 2010

(51) Int. Cl. B60R 7/04

(52) U.S. Cl. 224/482

(57) ABSTRACT

A rectangular open-topped plastic box designed to easily hold two (2) dip containers inside a vehicle to simplify and improve the on-the-go dining experience by increasing convenience of dip use and greatly reducing potential spills and similar messy incidents along with eliminating safety hazard issues for the driver, thus protecting all passengers.

Purpose: To easily hold up to two (2) dipping sauce containers inside a vehicle to ease and simplify the on-the-go dining experience.

Description: A rectangular open-topped plastic box designed to hold two (2) dip containers. The box has two (2) holes in the back to slide on to suction cups for attachment to window as primary mode of use.

Operation: Simply pull back the top of the dip and sit as many as two (2) of them in the containment box of the DIP GRIPPER. Once the dip is used, the disposable container can be removed by being plucked up from the finger notch on one side and replaced with another dip, if needed. Since the dipping sauce remains inside the disposable container, the DIP GRIPPER only needs minimal cleaning.

Ramifications: Radically improve the on-the-go dining experience, by increasing convenience of dip use and greatly reducing potential spills and similar messy incidents.

Possible Novel Features: Most dip containers are the same size, only varying in height from standard to tall. Some syrup containers are a bit smaller but still fit within the containing walls of the device. The DIP GRIPPER has also been designed to easily hold the large circular containers a few restaurants use for their sauces.

Advantages: Convenience and safety.

### BACKGROUND OF THE INVENTION

We live in a very fast-paced society, when there seldom seems a moment to waste. Leisure time has become increasingly important, which means the less time spent preparing food provides more available time for other desirable activities; after all, time is money. Most people who purchase fast food actually eat those convenient meals in their vehicles while in transit. Fast food places are opening up on almost every corner. It's not at all uncommon to see a McDonalds, KFC, Popeye's Chicken, Del Taco, a Burger King and several others all within a short distance of each other.

Three quarters of the money used to buy food just over a generation ago was spent on supplies to prepare meals at home. More than half the money is now spent buying prepared foods in restaurants, mainly fast food restaurants. A hamburger and french fries embodies the average American meal. The typical American consumes approximately three hamburgers and four orders of fries every week. Nearly one-quarter of the adult population in the United States visits a fast food restaurant on any given day. They enjoy delicious food wrapped in colored paper and cardboard. Fast food, both its production and consumption, is here to stay.

Despite the recession, Americans spend nearly $150 billion a year on fast food. That amount is up from $110 billion in 2000. In 1970, Americans spent roughly $6 billion on fast food. Starting as just a few hamburger and hot dog stands on the west coast, fast food now fills every facet of modern society, even available in schools and hospitals. More money is spent on fast food than books, movies and music combined.

From the hamburger stand to chicken shack, we can find a source for the food we want at a reasonable price. In response to the global economy, fast food chains are scrambling to offer their products at competitive prices, along with other discounts and promotions, such as $1 menus and cheap combination meals. To further enhance the dining excursion, these restaurants provide unique customization in the form of a variety of dipping sauces that can be used on chicken nuggets or strips, sandwich rolls and burritos. Those sauces commonly include creamy ranch, honey mustard, sweet and sour, spicy buffalo and barbecue. Those same-sized dip containers are also used for syrup for french toast sticks, icing for miniature cinnamon rolls and even caramel for apple slices.

Some have proposed similar condiment container holders (see, e.g., U.S. Pat. No. 5,667,119 and U.S. patent Ser. No. 10/820,932, respectively). The first such holder, although it also includes the ability to hold food item, requires a permanent attachment to the interior of the vehicle. The second holder requires the dip containers to be slid in from either end and is mainly intended for use on a completely horizontal surface, of which there are very few in modern vehicles.

Most vehicles only allow minimal space for eating. Using dips almost requires an extra hand to hold the dip container while the other two hands are used holding the food item and the one to be dipped in the sauce. The DIP GRIPPER provides that extra hand, furnishing a secure and stable platform from which to use dipping sauces. Without the DIP GRIPPER, the dip container might be placed on the dashboard or center console where it can slide and spill while the vehicle is in motion; or the dip might be inconveniently placed in a lap or held by someone else in the vehicle. The DIP GRIPPER could potentially eliminate safety hazard issues for the driver, thus protecting all passengers.

### SUMMARY

This rectangular open-topped plastic box eases and simplifies the on-the-go dining experience by increasing convenience of dip use and greatly reducing potential spills and similar messy incidents. According to the following specifications, this condiment container holder consists of two (2) long walls of the same width and height, abutting two (2) short walls, also of same width and height, all attached to a bottom at the lowest part of these walls.

### BRIEF DESCRIPTION OF THE DRAWINGS

FIG. 1 is a front panel of the invention illustrated in FIG. 6.

FIG. 2 is the left panel of the invention illustrated in FIG. 6.

FIG. 3 is the right panel of the invention illustrated in FIG. 6.

FIG. 4 is the bottom panel of the invention illustrated in FIG. 6.

FIG. 5 is the back panel of the invention illustrated in FIG. 6.

FIG. 6 is the isometric view of the invention, attached to a vertical surface with suction cups, shown in FIG. 5a.

### DETAILED DESCRIPTION OF THE INVENTION

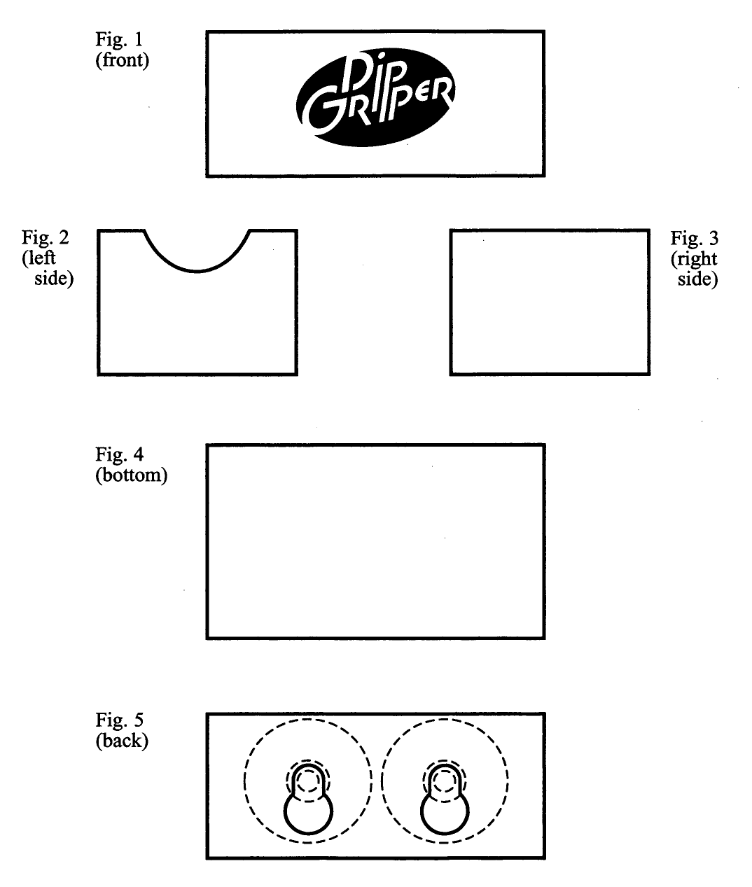

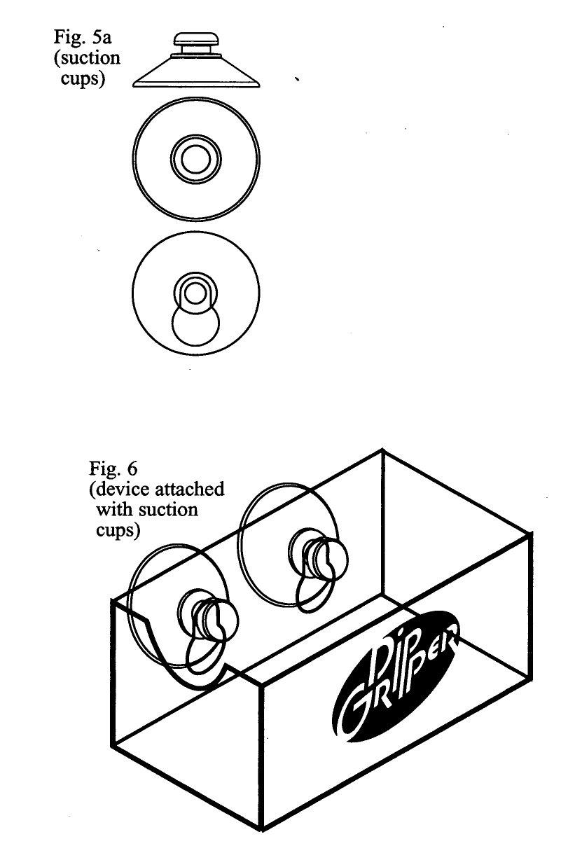

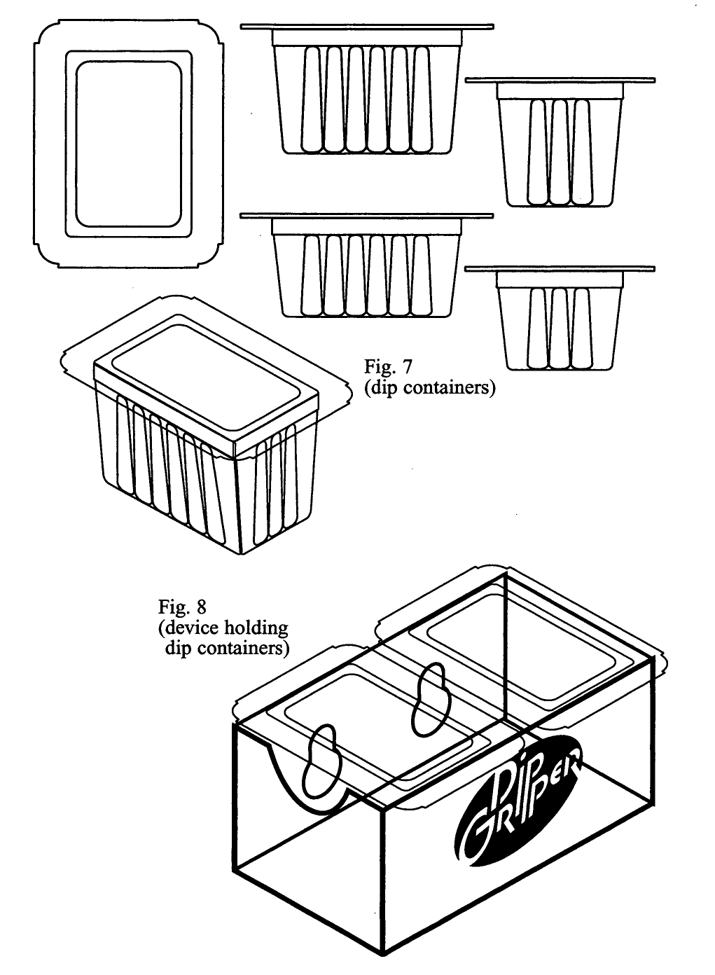

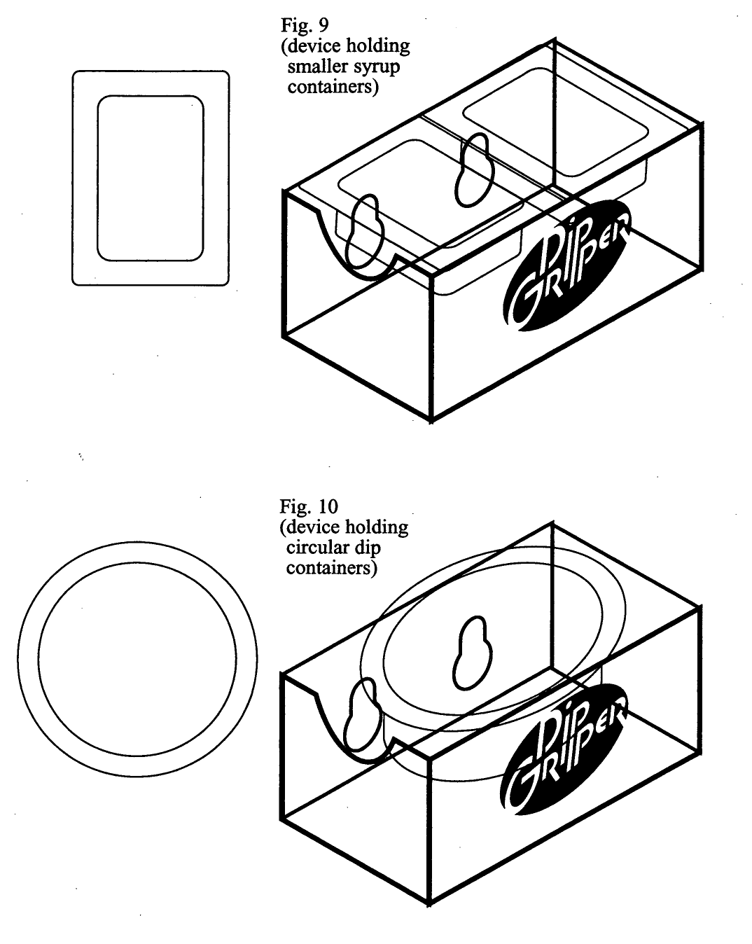

Referring to FIGS. 1 and 5, these panels are both 8 cm in width and 3.5 cm in height.

Referring to FIGS. 2 and 3, these panels are both 4.7 cm in width and 3.5 cm in height.

Referring to FIG. 4, the bottom panel is 8 cm in length and 4.7 cm in width.

Referring to FIG. 1, the front panel displays the item logo.

Referring to FIG. 2, the left side panel has a finger notch for plucking empty dip containers from the holding device.

Referring to FIG. 5, the back panel has two (2) holes in which to slide suction cups used to attach the device to vertical surfaces.

Referring to FIG. 5a, the suction cup is 3 cm in diameter and 1.3 cm in height and has a lip below the top button in which the device will rest when attached to vertical surfaces.

As shown in FIG. 6, the rectangular holding container hangs on the suction cups.

FIG. 7 shows the two heights, both tall and short, of standard dip containers widely used in the fast-food industry. The tops are the same on both heights.

As shown in FIG. 8, the device easily holds up to two (2) of these standard dip containers.

FIG. 9 shows the smaller syrup container and the device holding up to two (2) of them.

FIG. 10 shows the larger circular container and the device holding one (1) of them.

I claim:

1. A rectangular condiment container holder, consisting:
(a) two (2) long walls of the same width and height, abutting
(b) two (2) short walls, also of same width and height
(c) And a bottom attached to the lowest part of all the walls.

2. The rectangular condiment container holder of claim 1, wherein condiment containers of varied shapes and sizes comfortably and easily sit.

3. The rectangular condiment container holder of claim 1, wherein one of the longer walls has two (2) holes in which to slide on to suction cups for attachment to vertical surfaces.

4. The rectangular condiment container holder of claim 1 increases convenience of dip use and greatly reducing potential spills and similar messy incidents.

5. The rectangular condiment container holder of claim 1 potentially eliminates safety hazard issues for the driver, thus protecting all passengers in a vehicle.
